(19) United States
(12) Patent Application Publication
(10) Pub. No.: US 2025/0356782 A1
(43) Pub. Date: Nov. 20, 2025

(54) DISPLAY CONTROL DEVICE, HEAD-UP DISPLAY DEVICE, DISPLAY CONTROL METHOD, DISPLAY CONTROL PROGRAM, AND VEHICLE DISPLAY SYSTEM

(71) Applicant: Nippon Seiki Co.,Ltd., Niigata (JP)

(72) Inventors: Takumi Ogawa, Niigata (JP); Hanako Honma, Niigata (JP)

(21) Appl. No.: 19/182,820

(22) Filed: Apr. 18, 2025

(30) Foreign Application Priority Data
May 14, 2024 (JP) 2024-078561

(51) Int. Cl. G09G 3/00

(52) U.S. Cl. CPC G09G 3/001; G09G 2340/0471; G09G 2380/10

(57) ABSTRACT

A display control device including a control unit that performs display control in a case where a virtual object indicating a guidance direction at a target point is displayed in advance so as to move along a road surface, the virtual object is positioned at the target point, and the virtual object VOB is visually recognized by a viewer 4 aboard a vehicle as if the virtual object is present at a predetermined real space position in front of the vehicle, wherein the control unit performs control of displaying the virtual object such that a height of the virtual object on a first route when moving to the target point as viewed from the viewer is different from a height of the virtual object on a second route when approaching from the target point as viewed from the viewer.

### TECHNICAL FIELD

The present invention relates to a display control device and the like, for performing display control in a case where a virtual object is visually recognized by an occupant who is a viewer as if the virtual object is present at a predetermined real space position in front of a vehicle.

### BACKGROUND ART

For example, in Patent Document 1, as a method for indicating an intersection at which a right or left turn is to be made in a vehicle display system using a 3D display, a technique is described in which display of an arrow mark as a virtual object in a 3D space superimposed on a visually recognized real space position is positioned at a target intersection in advance, and the arrow mark approaches the target intersection at the same time as an own vehicle approaches the intersection, so that an occupant who is a viewer can visually recognize the intersection at which the right or left turn is to be made.

### PRIOR ART DOCUMENT

### Patent Document

Patent Document 1: DE 10 2013 224 307 A1 (see paragraphs to and FIGS. 3 to 5).

### SUMMARY OF INVENTION

### Technical Problem

According to the above vehicle display system described in Patent Document 1, when the vehicle approaches a predetermined real space position such as an intersection by a predetermined distance, a first arrow mark (refer to a graphical navigation instruction 109 illustrated in FIG. 3 in Patent Document 1) indicating a guide direction of the vehicle at the intersection is displayed in advance as if the first arrow mark moves along a road surface of a road, and when the vehicle comes closest to the predetermined real space position such as the intersection (a situation in which a turning maneuver of the vehicle is imminent), a second arrow mark (refer to graphical navigation instructions 110illustrated in FIGS. 4 and 5 in Patent Document 1) which is a virtual reality element is displayed, so that it is possible to guide the turning maneuver of the vehicle at the intersection or the like by an occupant (a driver or the like) who is a viewer in real time.

However, in the vehicle display system described in Patent Document 1 in which the display of the arrow mark, which is a virtual object, is positioned at the target intersection in advance, and the arrow mark approaches the target intersection at the same time as the own vehicle approaches the intersection, if a height of the arrow mark remains constant, there is a problem in that (1) it is not possible to clearly and intuitively convey a target point such as the intersection at which a right or left turn is to be made and a guidance direction thereof to an occupant who is a viewer. (2) In addition, since the arrow mark, which is a virtual object located at an intersection or the like, is disposed at a center of an angle of view of the display device, there is a problem in that the arrow mark covers a line of sight of the occupant who is the viewer, and a front field of view is blocked, which causes the occupant to feel annoyed.

Therefore, a first object of the present invention is to provide a display control device and the like capable of clearly and intuitively conveying, for example, a target point such as an intersection at which a right or left turn is to be made and a guidance direction thereof to an occupant who is a viewer by a virtual object. A second object of the present invention is to provide a display control device and the like capable of suppressing annoyance by securing a front field of view so that display of the virtual object does not obstruct a field of view of the viewer.

Other objects of the present invention will become apparent to those skilled in the art by referring to the aspects and best mode exemplified below, and the accompanying drawings.

### Solution to Problem

Hereinafter, in order to easily understand the outline of the present invention, aspects according to the present invention will be exemplified.

A first aspect according to the present invention is a display control device including a control unit that performs display control in a case where a virtual object indicating a guidance direction at a target point is displayed in advance so as to move along a road surface, the virtual object is positioned at the target point, and the virtual object is visually recognized by a viewer aboard a vehicle as if the virtual object is present at a predetermined real space position in front of the vehicle, wherein the control unit performs control of displaying the virtual object such that a height of the virtual object on a first route when moving to the target point as viewed from the viewer is different from a height of the virtual object on a second route when approaching from the target point as viewed from the viewer.

In the first aspect, the control unit performs control to display the virtual object such that a height of the virtual object on the first route when moving to the target point as viewed from the viewer is different from a height of the virtual object on the second route when approaching from the target point as viewed from the viewer. For example, FIG. 4 illustrates trajectories of the first route R1 and the second route R2 as viewed from the viewer 4 (here, the driver DR who is an occupant in the vehicle 1), and FIG. 5 illustrates a difference in height of the virtual object between the first route and the second route. In both FIGS. 4 and 5, arrowheads of arrow marks (VOB1, VOB2) as the virtual objects VOB in respective routes indicate guide directions of the virtual objects VOB. In FIG. 4, the arrow mark VOB1 on the first route R1 is directed in the same direction as a traveling direction of the vehicle 1 in order to move to the target point, and the arrow mark VOB2 on the second route is directed in the opposite direction to the traveling direction of the vehicle in order to approach the target point. In FIG. 5, the arrow mark VOB2, which is the virtual object VOB on the second route, is displayed at a position higher than the arrow mark VOB1, which is the virtual object VOB on the first route. As described above, when the arrow mark VOB1 on the first route R1 is viewed from the viewer (the driver DR who is an occupant in the vehicle), for example, the arrow mark VOB1 on the first route R1 can clearly and intuitively convey a distance to the target point by moving away at a low position, while the arrow mark VOB2 on the second route R2 can clearly and intuitively convey the target point to be turned right or left, for example, by approaching at a high position.

The “virtual object” is, for example, an augmented reality (AR) element that is displayed so as to be superimposed on the road surface or so as to be separated from the road surface and to travel on the road surface while changing its position at any time along the road surface, and refers to, for example, content represented by the arrow marks VOB1, VOB2, or the like indicating the guidance direction at the target point illustrated in FIG. 4. The “real space position” refers to a target point, for example, a point at which the vehicle needs to be turned, such as an intersection.

In a second aspect according to the first aspect, the control unit may perform control to display the virtual object on the first route in advance from a near side to a far side, and subsequently display the virtual object on the second route so as to approach the near side from the far side.

In the second aspect, the control unit performs control to display the virtual object on the first route in advance from the near side to the far side, and subsequently display the virtual object on the second route so as to approach the near side from the far side, and thus, the virtual object is displayed on the near side or the far side of a screen to be shifted away from a line of sight of the viewer (a line of sight in which the viewer faces a front horizontal direction) in both the first route and the second route. Therefore, it is possible to secure the field of view of the occupant who is the viewer, and to clearly and intuitively convey a sense of distance to the target point by the first route and the target point by the second route while suppressing annoyance due to obstruction of the field of view.

The “angle of view” is a viewing angle set for the display device, for example, when a head-up display device is used as the display device, the angle of view is defined as an angle range in which the viewer can visually recognize an image, based on a virtual line connecting eyes of the viewer and an outer edge of a display region. Here, a vertical direction of the display region is referred to as a vertical angle of view, and the horizontal direction is referred to as a horizontal angle of view. Typically, in the virtual image forming surface (virtual image display region), a vertical angle of view (first angle-of-view region) in which the viewer is located below a line of sight of the viewer facing a front horizontal direction is wide, and a vertical angle of view (second angle-of-view region) in which the viewer is located above the line of sight of the viewer facing the front horizontal direction is narrower than the first angle-of-view region. In the vertical angle of view (first angle-of-view region) in which the viewer is located below the line of sight of the viewer facing the front horizontal direction, a lower side can be defined as a “near side” and an upper side can be defined as a “far side”. On the other hand, in the vertical angle of view (second angle-of-view region) in which the viewer is located above the line of sight of the viewer facing the front horizontal direction, a lower side can be defined as a “far side” and an upper side can be defined as a “near side”.

In a third aspect according to the first or second aspect, the control unit may perform control to gradually increase the height of the virtual object on the first route and/or the height of the virtual object on the second route.

In the third aspect, for example, as illustrated in FIGS. 6A and 7B, the control unit performs control to gradually increase the height of the virtual object (arrow mark VOB1) on the first route R1, and/or the height of the virtual object (arrow mark VOB2) on the second route R2. In this way, by performing control to gradually increase the height of the arrow mark VOB1 as the virtual object VOB on the first route R1, and/or the height of the arrow mark VOB2 as the virtual object VOB on the second route R2, it is possible to suppress a sense of discomfort felt by the occupant who is a viewer with respect to the height of the virtual object VOB at the target point.

In a fourth aspect according to any one of the first to third aspects, when the target point is within a first distance on the second route, the control unit may perform control to gradually increase the height of the virtual object as the target point is approached, and when the target point is equal to or greater than the first distance, the control unit may perform control to make the height of the virtual object constant without depending on the target point.

In the fourth aspect, for example, as illustrated FIG. 6B, on the second route R2, when the target point is, for example, within 30 m (first distance), the control unit gradually increases the height of the virtual object VOB as the target point is approached, and when the target point is, for example, equal to or greater than 30 m (first distance), the control unit performs control to make the height of the virtual object VOB constant without depending on the target point, so that it is possible to secure the field of view for the occupant that is the viewer who is preparing for turning maneuver in front of the target point and to suppress the occupant from feeling annoyed, and it is possible for the occupant to perform a smooth turning maneuver such as turning right or left.

In a fifth aspect according to any one of the first to third aspects, when the target point is within a first distance on the second route, the control unit may perform control to gradually increase the height of the virtual object according to a first elevation rate defined by the height of the virtual object that changes depending on the distance to the target point as the target point is approached, and when the target point is equal to or greater than the first distance, the control unit may perform control to gradually increase the height of the virtual object at a second elevation rate smaller than the first elevation rate as the target point is approached.

In the fifth aspect, for example, as illustrated in FIG. 6C, on the second route R2, when the target point is within the first distance, the control unit performs control to gradually increase the height of the virtual object VOB according to the first elevation rate defined by the height of the virtual object VOB that changes depending on the distance to the target point as the target point is approached, and when the target point is equal to or greater than the first distance, the control unit performs control to gradually increase the height of the virtual object VOB at a second elevation rate smaller than the first elevation rate as the target point is approached. Here, for example, if it is considered that the height of the virtual object (VOB) should increase by approximately 1 meter as the distance to the target point decreases by 100 meters, the elevation rate would be 1/100. By varying the elevation rate, if it is considered that the height of the virtual object VOB increases by 0.5 meters as the distance to the target point decreases from 100 meters to 30 meters (equal to or more than 30 meters), and further increases by 0.5 meters as the distance decreases from the remaining 30 meters to 0 meter, the second elevation rate would be 0.7/70, and the first elevation rate would be 0.5/30. According to the fourth embodiment, by controlling the height of the virtual object VOB to gradually increase according to the first elevation rate, it is possible to convey to the occupant who is the viewer that the target point is gradually approached. Furthermore, by controlling the height of the virtual object VOB to gradually increase according to the second elevation rate smaller than the first elevation rate, it is possible to secure the field of view and to perform smooth turning maneuver such as turning right or left while suppressing the occupant from feeling annoyed.

In a sixth aspect according to any one of the first to third aspects, when the target point is approached by a predetermined distance on the second route, the control unit may perform control to display a shadowed image of the virtual object representing the height of the virtual object to be superimposed on the road surface.

In the sixth aspect, for example, as illustrated in FIG. 6D, when the target point is approached by a predetermined amount (for example, 30 m) on the second route R2, the control unit performs control to display a shaded image VOB2′ of the virtual object VOB (arrow mark VOB2) representing the height of the virtual object VOB (arrow mark VOB2) to be superimposed on the road surface. In this way, for example, by performing highlighting such as enlarging or darkening a shape of the shaded image VOB′ as the target point gets closer, it is possible to further increase a sense of augmented reality, and as a result, it is possible to attract an attention of the occupant who is the viewer.

In a seventh aspect according to any one of the first to third aspects, the control unit may perform control to make the height of the virtual object constant without depending on the target point on the first route.

In the seventh aspect, for example, as illustrated in FIG. 7A, the control unit performs control to make the height of the virtual object VOB (arrow mark VOB1) constant without depending on the target point on the first route R1. In this way, the first route R1 (an advance display that makes the arrow mark VOB1 appear to move away) during movement of the virtual object VOB (arrow mark VOB1) to the target point corresponding to the real space position allows the occupant who is the viewer to perceive (or estimate) the sense of distance to the target point. In other words, by making the height of the virtual object VOB constant, it is easy for the occupant who is the viewer to grasp the distance from the current position of the vehicle to the target point.

In an eighth aspect according to any one of the first to third aspects, on the first route, the control unit may perform control to make the height of the virtual object constant without depending on the target point when the target point is at a second distance or more, and to rapidly increase the height of the virtual object as the target point is moved away when the target point is within the second distance.

In the eighth aspect, for example, as illustrated in FIG. 7C, on the first route R1, the control unit performs control to make the height of the virtual object VOB (arrow mark VOB1) constant without depending on the target point when the target point is at, for example, 10 m (second distance) or more, and to rapidly increase the height of the virtual object VOB (arrow mark VOB1) as the target point is moved away when the target point is within 10 m (second distance). In this way, the height of the arrow mark VOB1 as the virtual object VOB is rapidly increased from a constant state at, for example, 10 m (second distance), so that the arrow mark VOB1 can attract an attention, and as a result, it is possible to clearly convey the target point to turn right or left to the occupant who is the viewer.

In a ninth aspect according to any one of the first to third aspects, the control unit may perform control to gradually increase the height of the virtual object as the target point is moved away on the first route, and to make the height of the virtual object constant without depending on the distance to the target point when the target point is within a second distance.

In the ninth aspect, for example, as illustrated in FIG. 7D, on the first route R1, the control unit performs control to gradually increase the height of the virtual object VOB (arrow mark VOB1) as the target point is moved away, and to make the height of the virtual object VOB (arrow mark VOB1) constant without depending on the distance to the target point when the target point is, for example, within 30 m (within the second distance). In this way, on the first route R1, the arrow mark VOB1 as the virtual object VOB is moved from the lower side (near side) of the angle of view to the target point (the arrow mark VOB1 is moved away to the upper side (far side) of the angle of view), so that it is possible to temporarily secure the field of view of the occupant (driver DR) who is the viewer and suppress annoyance, and thereafter, the height of the arrow mark is fixed and displayed at a center of the angle of view, so that it is possible to clearly convey the target point to the occupant who is the viewer.

A tenth aspect according to the present invention is a head-up display device that displays a virtual object so as to be visually recognized by a viewer aboard a vehicle as if a virtual object is present at a predetermined real space position in front of the vehicle, the head-up display device including an image display unit, and a control unit that performs control to display the virtual object on the image display unit such that a height of the virtual object on a first route in moving to a target point corresponding to the predetermined real space position as viewed from the viewer is different from a height of the virtual object on a second route in approaching the target point as viewed from the viewer.

In the tenth aspect, the control unit in the head-up display device performs control to display the virtual object on the image display unit such that the height of the virtual object on the first route in moving to the target point corresponding to the real space position as viewed from the viewer is different from the height of the virtual object on the second route in approaching the target point as viewed from the viewer. Therefore, it is possible to provide a head-up display device that can intuitively convey the distance to the target point to the occupant who is the viewer by, for example, the virtual object moving away (moving to the target point) at a lower position as viewed from the viewer on the first route, and can clearly and intuitively convey the target point to turn right or left by, for example, the virtual object approaching at a higher position as viewed from the viewer on the second route.

An eleventh aspect according to the present invention is a display control method for causing a viewer aboard a vehicle to visually recognize a virtual object as if the virtual object is present at a predetermined real space position in front of the vehicle, the method including a step of generating the virtual object indicating a guidance direction at a target point corresponding to the predetermined real space position, and a step of performing control to display the virtual object such that a height of the virtual object on a first route in moving to the target point as viewed from the viewer is different from a height of the virtual object on a second route in approaching the target point as viewed from the viewer.

In the eleventh aspect, for example, as illustrated in FIG. 3, the display control method includes a step (ST101) of generating the virtual object VOB indicating the guidance direction at the target point corresponding to the predetermined real space position, and steps (ST102 to ST105) of performing control to display the virtual object VOB such that the height of the virtual object VOB on the first route in moving to the target point as viewed from the viewer is different from the height of the virtual object VOB on the second route in approaching the target point as viewed from the viewer. In this way, it is possible to provide the display control method that can clearly and intuitively convey the distance to the target point to the occupant who is the viewer by, for example, the virtual object VOB moving away (moving to the target point) at a lower position as viewed from the viewer on the first route, and can clearly and intuitively convey the target point to turn right or left by, for example, the virtual object VOB approaching at a higher position as viewed from the viewer on the second route.

A twelfth aspect according to the present invention is a display control program of a display control device including a control unit that performs display control for causing a viewer aboard a vehicle to visually recognize a virtual object as if the virtual object is present at a predetermined real space position in front of the vehicle, the display control program causing the control unit to perform a process of generating the virtual object indicating a guidance direction at a target point corresponding to the predetermined real space position, and a process of performing control to display the virtual object such that a height of the virtual object on a first route in moving to the target point as viewed from the viewer is different from a height of the virtual object on a second route in approaching the target point as viewed from the viewer.

In the twelfth aspect, for example, as illustrated in FIG. 3, the control unit included in the display control device performs a process (ST101) of generating the virtual object VOB indicating the guidance direction at the target point corresponding to the predetermined real space position, and processes (ST102 to ST105) of performing control to display the virtual object VOB such that the height of the virtual object VOB on the first route in moving to the target point as viewed from the viewer is different from the height of the virtual object VOB on the second route in approaching the target point as viewed from the viewer. In this way, it is possible to provide the display control program that can clearly and intuitively convey the distance to the target point to the occupant who is the viewer by, for example, the virtual object VOB moving away (moving to the target point) at a lower position as viewed from the viewer on the first route, and can clearly and intuitively convey the target point to turn right or left by, for example, the virtual object VOB approaching at a higher position as viewed from the viewer on the second route.

A thirteenth aspect is a vehicle display system including a head-up display device that causes a viewer aboard a vehicle to visually recognize a virtual object as if the virtual object is present at a predetermined real space position in front of the vehicle, a navigation device that generates navigation information including a target point, and a display control device that performs display control of the head-up display device, wherein the display control device generates the virtual object indicating a guidance direction at the target point acquired by the navigation device, and performs control to display the virtual object on the head-up display device such that a height of the virtual object on a first route when the vehicle moves to the target point corresponding to the real space position as viewed from the viewer is different from a display height of the virtual object on a second route when the target point is approached as viewed from the viewer.

In the thirteenth aspect, the display control device in the vehicle display system generates the virtual object indicating the guidance direction at the target point acquired by the navigation device, and performs control to display the virtual object on the head-up display device such that the height of the virtual object on the first route when the vehicle moves to the target point corresponding to the real space position as viewed from the viewer is different from the display height of the virtual object on the second route when the target point is approached as viewed from the viewer. In this way, it is possible to provide the vehicle display system that can clearly and intuitively convey the distance to the target point to the occupant who is the viewer by, for example, the virtual object moving away (moving to the target point) at a lower position as viewed from the viewer on the first route, and can clearly and intuitively convey the target point to turn right or left by, for example, the virtual object approaching at a higher position as viewed from the viewer on the second route.

Those skilled in the art will readily understand that the exemplified aspects according to the present invention may be modified without departing from the spirit of the present invention.

### BRIEF DESCRIPTION OF DRAWINGS

FIG. 1 is a diagram illustrating an example of a configuration of a vehicle display system including a parallax-type 3D head-up display device.

FIG. 2 is a functional block diagram illustrating a configuration example of a control unit included in a display control device according to an embodiment of the present invention.

FIG. 3 is a flowchart illustrating operations of the display control device (control unit) according to an embodiment according to the present invention.

FIG. 4 is a diagram that is cited for describing an operation of the display control device according to an embodiment of the present invention, and that illustrates trajectories of a first route and a second route as viewed from a viewer.

FIG. 5 is a diagram that is cited for describing an operation of the display control device according to an embodiment of the present invention, and that illustrates a difference in height of a virtual object between a first route and a second route.

FIG. 6A is a diagram illustrating the trajectory of the second route in an example 1.

FIG. 6B is a diagram illustrating the trajectory of the second route in an example 2.

FIG. 6C is a diagram illustrating the trajectory of the second route in an example 3.

FIG. 6D is a diagram illustrating an example of a shaded image of a virtual object on the second route in an example 4.

FIG. 7A is a diagram illustrating the trajectory of the first route in an example 5.

FIG. 7B is a diagram illustrating the trajectory of the first route in an example 6.

FIG. 7C is a diagram illustrating the trajectory of the first route in an example 7.

FIG. 7D is a diagram illustrating the trajectory of the first route in an example 8.

FIG. 8 is a block diagram illustrating a modification.

### DESCRIPTION OF EMBODIMENTS

The best mode described below is used to facilitate understanding of the present invention. Therefore, those skilled in the art should note that the present invention is not unreasonably limited by the embodiment described below (hereinafter referred to as the present embodiment).

### Configuration of Embodiment

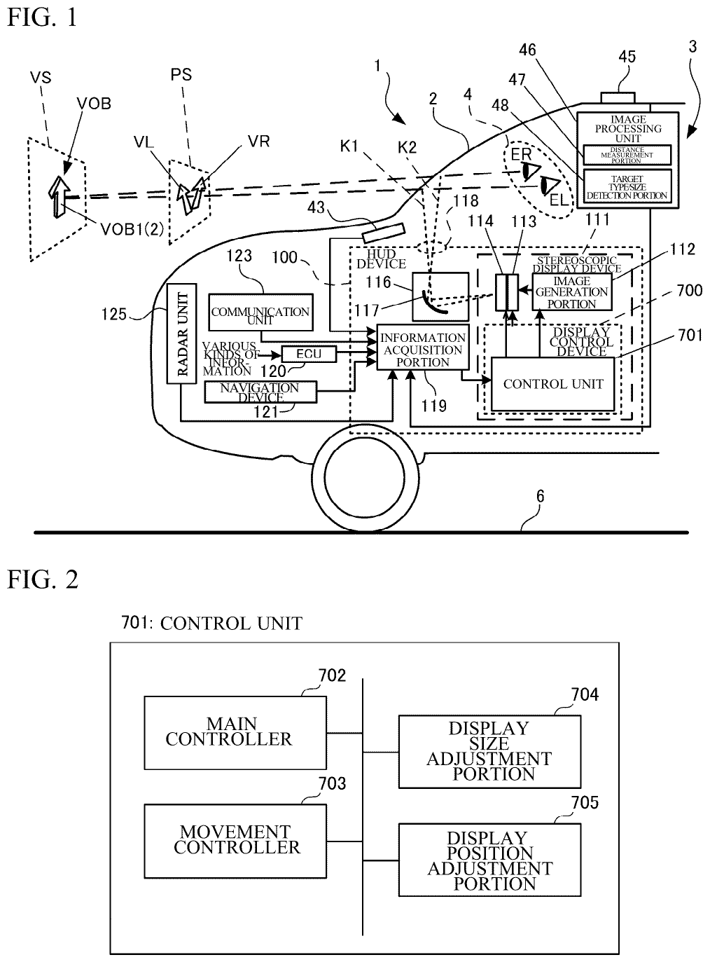

Reference is made to FIG. 1. FIG. 1 is a diagram illustrating an example of a configuration of a vehicle display system 3 including a parallax-type 3D head-up display device (HUD device 100).

In FIG. 1, a direction along a line segment connecting left and right eyes EL and ER of a viewer 4 (in other words, a width direction of a vehicle 1) is defined as a left-right direction (or a lateral direction: X direction), a direction along a line segment perpendicular to the left-right direction and perpendicular to the ground or a surface corresponding to the ground (a road surface 6 of a road) is defined as an up-down direction (or a height direction: Y direction), and a direction along a line segment perpendicular to both the left-right direction and the up-down direction (a direction in which the vehicle 1 moves forward and backward) is defined as a front-back direction (Z direction). Here, the positive Z direction is a forward direction, and the negative Z direction is a backward direction.

A vehicle display system 3 included in the vehicle (own vehicle) 1 of FIG. 1 has a pupil detection camera 43 for pupil (or face) detection, which detects the eye direction and position of the left eye EL and the right eye ER of the viewer 4 (occupant (driver, or the like) in the vehicle 1), a front (broadly, circumference) imaging camera (for example, stereo camera) 45, an image processing unit 46 (including a distance measurement portion 47 and a target type/size detection portion 48), an HUD device 100, a communication unit (having functions such as GPS communication and intervehicle communication) 123, and an electronic control unit (ECU) 120 capable of collecting various kinds of information about the vehicle 1 (for example, light on/off information, vehicle speed information, engine information, or the like).

The vehicle display system 3 may also include a navigation device 121. The navigation device 121 includes, for example, a positioning unit such as a global positioning system (GPS), has map information, and can generate navigation information that includes at least a current position of the vehicle 1 and a distance to a predetermined real space position, such as an intersection. The navigation device 121 can acquire latest map information and update a map database through, for example, communication with an external center (not illustrated) via a Vehicle-to-X (V2X) type communication system. Here, the map information stored in the map database is mapping data which is digitized to represent traveling environments of the vehicle 1. The mapping data is particularly preferably digital data of a high-accuracy dynamic map. Here, the “dynamic map” is a digital map obtained by combining enormous dynamic information that changes every moment, such as traffic regulations, construction information, accidents, congestion, pedestrians, and signal information, as well as static information such as high-accuracy three dimensional position information (road surface information, oblique line information, and three dimensional structures).

The vehicle display system may include a radar unit 125 or the like as distance measurement means, as necessary. The distance measurement means can be used, for example, to measure a distance from the vehicle 1 to a vehicle in front (forward target). On the basis of the measurement result, for example, display control such as performing parallax-type 3D display in a range where there is no forward target can be performed.

The distance measurement portion 47 included in the image processing unit 46 may refer to a pair of left and right original images imaged by, for example, a stereo camera as the imaging camera 45, detect a parallax with respect to the same body (defined as a forward target) by, for example, stereo matching for searching corresponding points of the images, and measure a distance to the forward target by the principle of triangulation based on the parallax.

In addition, the radar unit 125 may emit a radio wave toward a target (forward target) and measure a reflected wave of the radio wave to measure the distance and direction to the target (forward target).

An information acquisition portion 119 of the HUD device 100 appropriately acquires measured distance information or the like and supplies the information to a control unit 701 of a stereoscopic display device 111. The HUD device 100 is installed in, for example, a dashboard (not illustrated) of the vehicle 1. The HUD device 100 has the stereoscopic display device 111, an optical system 116, a light emission window 118, and the information acquisition portion 119. The information acquisition portion 119 can acquire various kinds of information from the communication unit 123, the ECU 120, the radar unit 125, the image processing unit 46, and the like.

Here, the stereoscopic display device 111 is a parallax-type 3D display device. The stereoscopic display device (parallax-type 3D display device) 111 has an image generation portion 112, an image display unit (which is a display panel such as a liquid crystal display device and has an image display surface for displaying an image) 113, a light beam separation portion 114 which has a lenticular lens, a parallax barrier, or the like and separates light emitted from the image display surface into light beams for the left and right eyes, and a display control device 700 according to the present embodiment.

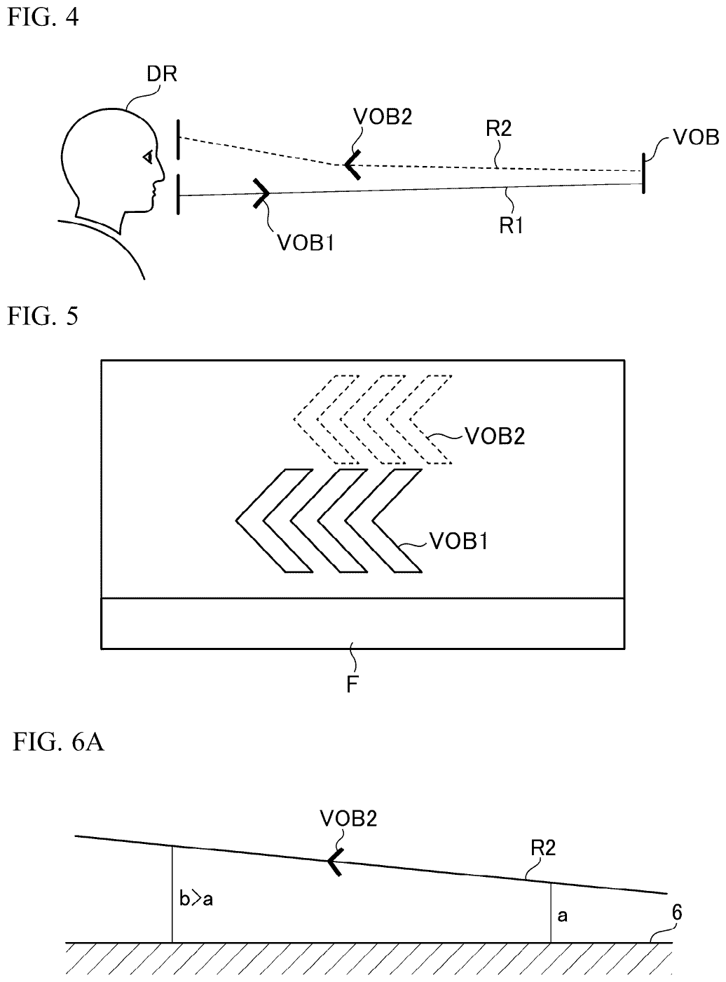

The display control device 700 according to the present embodiment includes the control unit 701 for performing display control in a case where a virtual object is visually recognized by the viewer 4 aboard the vehicle 1 as if the virtual object VOB is present at a predetermined real space position in front of a vehicle 1. Here, the “virtual object VOB” is, for example, an augmented reality (AR) element that is displayed so as to be superimposed on the road surface 6 or so as to be separated from the road surface 6 and to travel on the road surface 6 while changing its position at any time along the road surface 6, and refers to, for example, content represented by the arrow marks or the like (refer to VOB1 and VOB2 in FIG. 4) indicating the guidance direction at the target point illustrated in FIG. 4. The virtual object VOB is not particularly limited as long as it indicates a guidance direction at a real space position regardless of the arrow marks VOB1 and VOB2. The “real space position” refers to a target point, for example, a point at which the vehicle 1 needs to be turned, such as an intersection.

The control unit 701 can perform control to display the virtual object VOB such that the height of the arrow mark VOB1 as the virtual object VOB on a first route (for example, refer to R1 in FIG. 4) when moving to a real space position such as an intersection, which is a target point as viewed from the viewer 4, is different from the height of the arrow mark VOB2 as the virtual object VOB on a second route (for example, refer to R2 in FIG. 4) when approaching from the target point as viewed from the viewer 4 (refer to FIG. 5). For example, on the first route R1, the virtual object VOB (the arrow mark VOB1) is displayed at a lower position and moves away as viewed from the viewer 4 (advance display of moving to the target point), while on the second route, the virtual object VOB (the arrow mark) is displayed at a higher position and moves closer as viewed from the viewer 4. Note that the arrow mark VOB1 and the arrow mark VOB2 are the same virtual object VOB, and are illustrated separately for convenience of explanation.

The control unit 701 can perform control to display the virtual object VOB on the first route R1 in advance from a near side to a far side, and subsequently display the virtual object VOB on the second route R2 so as to approach the near side from the far side. That is, the control unit 701 performs control to display the virtual object VOB on the near side or the far side of a screen to shift away from a line of sight of the viewer 4 (a line of sight in which the viewer 4 faces a front horizontal direction) in both the first route R1 and the second route R2. Therefore, it is possible to secure the field of view of the occupant (driver or the like) who is the viewer 4, and to clearly and intuitively convey a sense of distance to the target point by the first route and the target point by the second route while suppressing annoyance due to obstruction of the field of view. The “angle of view” is a viewing angle set on a virtual image forming surface PS of the HUD device 100, for example, when a head-up display device is used as the display device, the angle of view is defined as an angle range in which the viewer 4 can visually recognize an image, based on a virtual line connecting eyes (a left eye EL and a right eye ER) of the viewer 4 and an outer edge of virtual image forming surface PS. Here, a vertical direction of the virtual image forming surface PS is referred to as a vertical angle of view, and the horizontal direction is referred to as a horizontal angle of view. Typically, in the virtual image forming surface (virtual image display region), a vertical angle of view (first angle-of-view region) in which the viewer 4 is located below a line of sight of the viewer facing a front horizontal direction is wide, and a vertical angle of view (second angle-of-view region) in which the viewer 4 is located above the line of sight of the viewer facing the front horizontal direction is narrower than the first angle-of-view region. In the vertical angle of view (first angle-of-view region) in which the viewer 4 is located below the line of sight of the viewer facing the front horizontal direction, a lower side can be defined as a “near side” and an upper side can be defined as a “far side”. On the other hand, in the vertical angle of view (second angle-of-view region) in which the viewer 4 is located above the line of sight of the viewer facing the front horizontal direction, a lower side can be defined as a “far side” and an upper side can be defined as a “near side”.

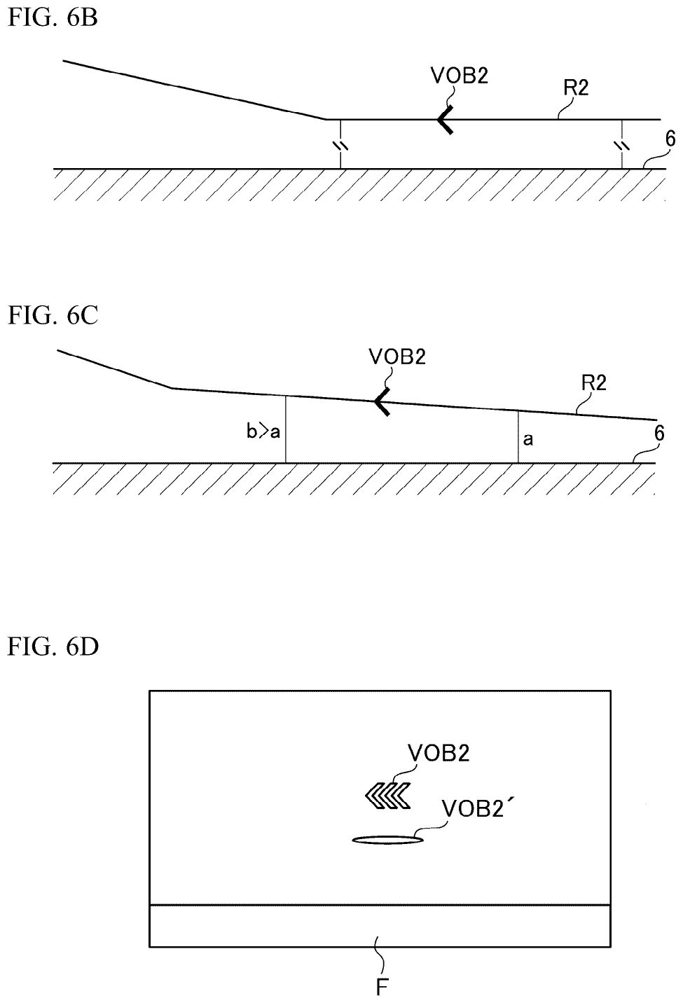

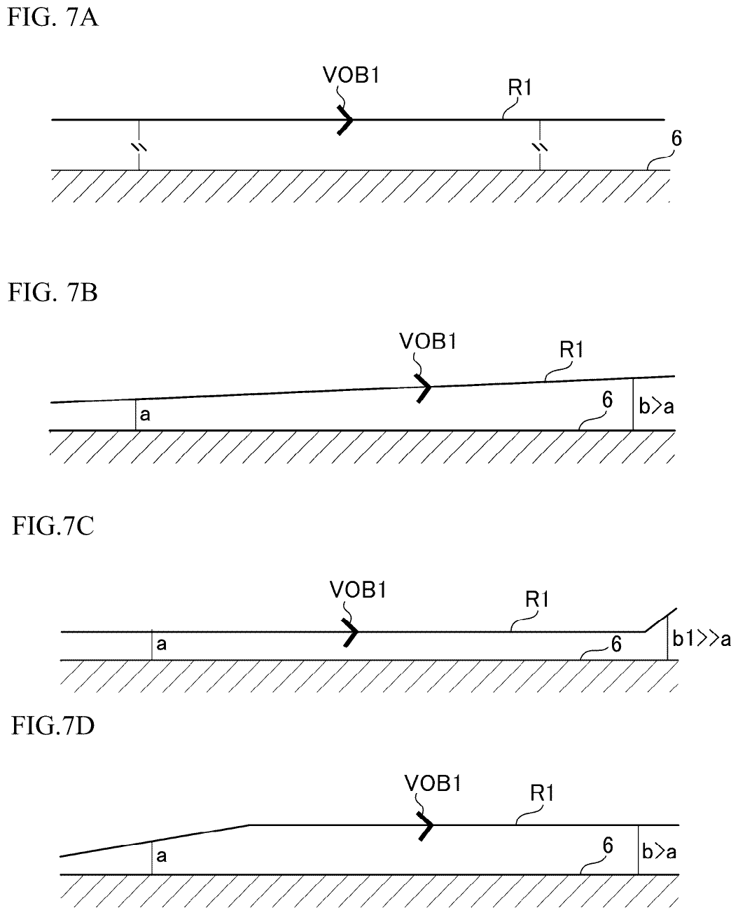

The control unit 701 performs control to gradually increase the height of the arrow mark VOB1 as the virtual object VOB on the first route R1, and/or the height of the arrow mark VOB2 as the virtual object VOB on the second route R2 (refer to FIGS. 6A and 7B), thereby suppressing a sense of discomfort felt in the height of the virtual object VOB (arrow marks VOB1, VOB2) at the target point.

On the second route R2, when the target point is, for example, within 30 m (first distance), the control unit 701 gradually increases the height of the virtual object VOB as the target point is approached, and when the target point is, for example, equal to or greater than 30 m (first distance), the control unit 701 performs control to make the height of the virtual object VOB constant without depending on the target point (refer to FIG. 6B), thereby securing the field of view for the occupant that is the viewer 4 who is preparing for turning maneuver in front of the target point, suppressing the occupant from feeling annoyed, and enabling a smooth turning maneuver such as turning right or left.

On the second route R2, when the target point is within, for example, 30 m (first distance), the control unit 701 can perform control to gradually increase the height of the virtual object VOB according to the first elevation rate defined by the height of the virtual object VOB that changes depending on the distance to the target point as the target point is approached, and when the target point is equal to or greater than the first distance, the control unit 701 can perform control to gradually increase the height of the virtual object VOB at a second elevation rate smaller than the first elevation rate as the target point is approached (refer to FIG. 6C).

Here, for example, if it is considered that the height of the virtual object (VOB) should increase by approximately 1 meter as the distance to the target point decreases by 100 meters, the elevation rate would be 1/100. Here, by varying the elevation rate, if it is considered that the height of the virtual object VOB increases by 0.5 meters as the distance to the target point decreases from 100 meters to 30 meters (equal to or more than 30 meters), and further increases by 0.5 meters as the distance decreases from the remaining 30 meters to 0 meter, the “second elevation rate” would be 0.7/70, and the “first elevation rate” would be 0.5/30. In this way, by controlling the height of the virtual object VOB to gradually increase according to the first elevation rate, it is possible to convey to the occupant who is the viewer that the target point is gradually approached. Furthermore, by controlling the height of the virtual object VOB to gradually increase according to the second elevation rate smaller than the first elevation rate, it is possible to secure the field of view and to perform smooth turning maneuver such as turning right or left while suppressing the occupant from feeling annoyed.

When the target point is approached by a predetermined amount on the second route R2, the control unit 701 can perform control to display a shaded image of the virtual object VOB representing the height of the virtual object VOB to be superimposed on the road surface. For example, as illustrated in FIG. 6D, a shaded image VOB′ of the virtual object VOB is displayed on the road surface 6, and the height of the virtual object VOB is represented by the shaded image VOB′ (for example, a shape of the shaded image VOB′ is enlarged or darkened so as to be highlighted as the target point gets closer), and thus it is possible to further increase a sense of AR and attract an attention of the occupant who is the viewer 4.

Further, the control unit 701 performs control to make the height of the virtual object VOB constant without depending on the target point on the first route R1 (refer to FIG. 7A), and makes it easy for the occupant who is the viewer 4 to grasp the distance from the current position of the vehicle 1 to the target point.

On the first route R1, the control unit 701 can perform control to make the height of the virtual object VOB constant without depending on the target point when the target point is at, for example, 10 m (second distance) or more, and to rapidly increase the height of the virtual object VOB as the target point is moved away when the target point is within the second distance (refer to FIG. 7C). In this way, the height of the virtual object VOB is rapidly increased from a constant state at, for example, 10 m (second distance), so that the virtual object VOB can attract an attention, and as a result, it is possible to clearly convey the target point to the occupant who is the viewer 4.

Further, on the first route R1, the control unit 701 can perform control to gradually increase the height of the virtual object VOB as the target point is moved away, and to make the height of the virtual object VOB constant without depending on the distance to the target point when the target point is, for example, within the 10 m (second distance) (refer to FIG. 7D). On the first route R1, the virtual object VOB (arrow mark VOB1) is moved from the lower side (near side) of the angle of view to the target point (the arrow mark VOB1 is moved away to the upper side (far side) of the angle of view), so that it is possible to temporarily secure the field of view of the occupant who is the viewer 4 and suppress annoyance, and thereafter, the height of the virtual object VOB (arrow mark VOB1) is fixed and displayed at a center of the angle of view, so that it is possible to clearly convey the target point to the occupant who is the viewer 4.

Further, the control unit 701 can also control, for example, the operation of the image generation portion (specifically, for example, image rendering) 112 or the image display unit 113. The control unit 701 can switch 2D display/3D display, and can also perform visibility control of a content image as a crosstalk countermeasure. The configuration of the control unit 701 will be described later with reference to FIG. 2.

The optical system 116 has a curved mirror (concave mirror or the like) 117 which reflects light from the light beam separation portion 114 and projects display light K1 and K2 of an image onto a windshield (member to be projected) 2. However, other optical members (a lens, an auxiliary reflecting mirror, and the like) may be further included.

In FIG. 1, viewpoint images having a parallax (also referred to as “parallax images”) for the left and right eyes are displayed by the stereoscopic display device 111 of the HUD device 100. As illustrated in FIG. 1, the respective parallax images are displayed as virtual images VL and VR on a virtual image display surface (image forming surface) PS as a first display surface. A stereoscopic image having a sense of depth (stereoscopic image, 3D image) is displayed as a virtual object VOB on a convergence surface (stereoscopic image display surface) VS as a second display surface located on the farther side than the first display surface PS as viewed from the viewer 4.

When 2D display control is executed instead of 3D display control, a planar virtual image is displayed on the first display surface PS. Since grasp of the sense of distance can be expressed by a change in a display size and a change in a display position (depending on a moving speed of the vehicle), the grasp of the distance sense can be realized not only by a 3D display for controlling a convergence angle and a focal point but also by a pseudo 2D display. The present invention is not limited to the HUD device 100, and may be applied to a display device such as a center information display CID or a head-mounted display HMD.

Reference is made to FIG. 2. FIG. 2 is a functional block diagram illustrating a preferred configuration example of the control unit 701 in FIG. 1. The control unit 701 includes at least a main controller 702, a movement controller 703, a display size adjustment portion 704, and a display position adjustment portion 705.

The main controller 702 performs sequence control of the movement controller 703, the display size adjustment portion 704, and the display position adjustment portion 70 so that the control unit 701 performs control to display the virtual object VOB such that the height of the virtual object VOB (arrow mark VOB1) on the first route (for example, refer to R1 in FIG. 4) when moving to, for example, an intersection, which is a target point as viewed from the viewer 4, is different from the height of the virtual object VOB (arrow mark VOB2) on the second route (for example, refer to R2 in FIG. 4) when approaching from the target point as viewed from the viewer 4. Accordingly, the main controller 702 can cause the virtual object VOB indicating the guidance direction at the target point corresponding to the predetermined real space position to be displayed in advance so as to move along the road surface 6, subsequently position the virtual object VOB at the target point, and cause the viewer 4 aboard the vehicle 1 to visually recognize the virtual object VOB as if the virtual object VOB is present at the predetermined real space position in front of the vehicle 1.

The movement controller 703 performs movement control to adjust the display size and the display position of the arrow mark VOB1 so that the arrow mark (for example, refer to VOB1 in FIG. 4) as the virtual object VOB moves at a high speed (for example, moves in one second) from a predetermined position to a predetermined real space position. Further, the movement controller 703 can perform movement control to adjust the display size and the display position of the arrow mark VOB2 so that the arrow mark (for example, refer to VOB2 in FIG. 4) so that the virtual object VOB is positioned at a predetermined real space position in a state in which turning direction at the predetermined real space position is guided. Note that the virtual object VOB is erased when the vehicle 1 (the occupant who is the viewer 4) starts a turning maneuver along the guidance direction.

When executing the movement control described above, the movement controller 703 can adjust the display size of the arrow mark VOB1 as the virtual object VOB according to the distance to the predetermined real space position acquired from, for example, the navigation device 121 by cooperating with the display size adjustment portion 704, and can adjust the display position of the arrow mark VOB2 as the virtual object VOB according to the guidance directions at the predetermined real space position by operating in cooperation with the display position adjustment portion 705. Accordingly, the movement controller 703 can perform control to display the virtual object VOB such that the height of the arrow mark VOB1 as the virtual object VOB on a first route (for example, refer to R1 in FIG. 4) when moving to the target point corresponding to the predetermined real space position as viewed from the viewer 4, is different from the height of the arrow mark VOB2 as the virtual object VOB on a second route (for example, refer to R2 in FIG. 4) when approaching from the target point as viewed from the viewer 4.

The display size adjustment portion 704 and the display position adjustment portion 705 can, for example, prepare function (characteristic line) indicating relationships between a distance and a display size adjusted to rates of change different from the real world rate of change in size (rate of change in size corresponding to a real object existing in the real space), and change the display sizes and display positions of the arrow marks VOB1 and VOB2 as the virtual objects VOB using the function (characteristic line) as necessary, thereby performing display of a size that is easy to see to a certain extent at a far distance, while suppressing the display size from becoming too large at a near distance, and realizing appropriate changes in the display size from a far distance to a near distance to realize perspective display without a sense of discomfort (refer to Japanese Patent Application No. 2024-14544, which is a prior application filed on Feb. 2, 2024 by the same applicant as the present applicant).

In addition, in the display control device 700 according to the present embodiment, the above-described functions performed by the display control device 700 (control unit 701) are realized by a program executed by a computer.

In this case, the control unit 701 includes, for example, a computer including a processor and at least one memory (for example, ROM or RAM) as hardware for executing the above-described program. In addition, at least a part of the above-described functions can be realized by a logic circuit. For example, an integrated circuit in which a logic circuit is formed is also included in the scope of the present invention.

### Operation of Embodiment

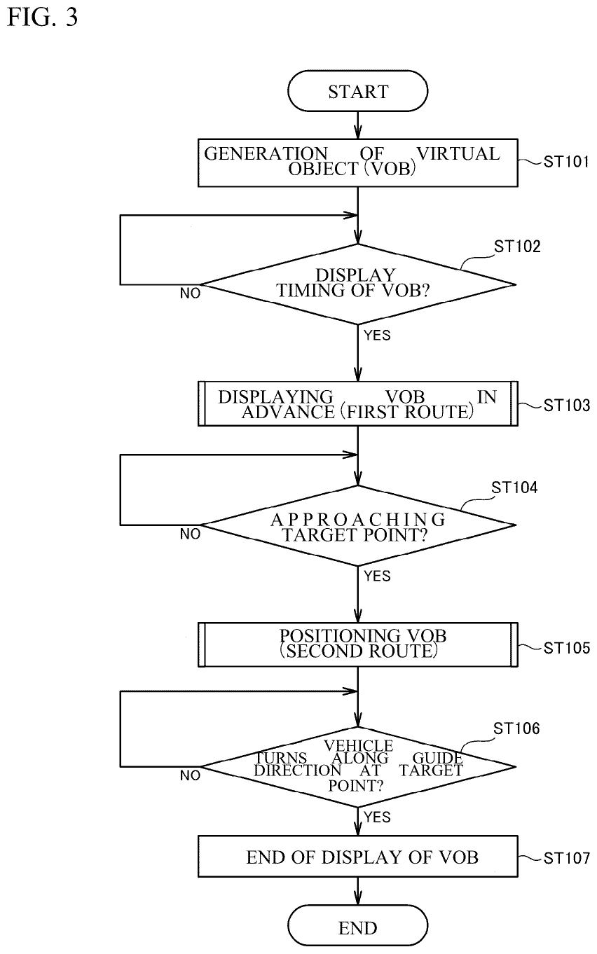

FIG. 3 is a flowchart illustrating operations of the display control device 700 (control unit 701) according to the present embodiment. FIGS. 4 and 5 are diagrams cited for describing an operation of the display control device 700 according to the present embodiment, FIG. 4 is a diagram illustrating the trajectories of the first route R1 and the second route R2 as viewed from the viewer 4, and FIG. 5 is a diagram illustrating a difference in height of the virtual objects VOB (arrow marks VOB1 and VOB2) between the first route R1 and the second route R2.

FIGS. 6A, 6B, 6C, 6D, 7A, 7B, 7C, and 7D are diagrams cited to describe operations of each example in the display control device 700 according to the present embodiment. Specifically, FIG. 6A illustrates the trajectory of the second route R2 in Example 1, FIG. 6B illustrates the trajectory of the second route R2 in Example 2, FIG. 6C illustrates the trajectory of the second route R2 in Example 3, FIG. 6D illustrates an example of the shaded image VOB2′ of the virtual object VOB on the second route R2 in Example 4, FIG. 7A illustrates the trajectory of the second route R2 in Example 5, FIG. 7B illustrates the trajectory of the second route R2 in Example 6, FIG. 7C illustrates the trajectory of the second route R2 in Example 7, and FIG. 7D illustrates the trajectory of the second route R2 in Example 8.

The operation of the display control device 700 (control unit 701) according to the present embodiment illustrated in FIGS. 1 and 2 will be described in detail below with reference to FIGS. 3 to 7D.

Reference is made to FIG. 3. In the display control device 700 according to the present embodiment, the control unit 701 performs control to wait for a display timing of the virtual object VOB generated by the image generation portion 112 in step ST101 (“YES” at step ST102), and to display the virtual object VOB on the image display unit 113 of the HUD device 100 (step ST103). Here, the display timing of the virtual object VOB in step ST102 can be calculated by the control unit 701 based on navigation information acquired from the navigation device 121, the distance to predetermined room space position such as an intersection acquired via the ECU120, the speed of the own vehicle 1, and the like, and is set to, for example, the timing when the position of the vehicle is about 300 m before the intersection.

At the step ST103, the control unit 701 displays the arrow mark VOB1 as the virtual object VOB in advance on the first route R1 (as viewed from the viewer 4) At this time, in the control unit 701, under the sequence control by the main controller 702, the movement controller 703 performs control to cause the virtual object VOB to jump to the target point, which is a predetermined real space position, and display the virtual object VOB as if the virtual object VOB moved along the road surface 6. When the arrow mark VOB1 jumps to the target point, the movement controller 703 operates in cooperation with the display size adjustment portion 704 and the display position adjustment portion 705 to adjust the display size and the display position of the arrow mark VOB1 and display the arrow mark VOB1 as if the arrow mark VOB 1 is moved, instead of actually moving the arrow mark VOB1 in terms of distance. At this time, the display of the arrow mark VOB1 is started with slide-in or fade-in from a bottom of a screen of the image display unit 113.

Here, the display size adjustment portion 704 and the display position adjustment portion 705 can, for example, prepare function (characteristic line) indicating relationships between a distance and a display size adjusted to rates of change different from the real world rate of change in size (rate of change in size corresponding to a real object existing in the real space), and change the display sizes and display positions of the virtual objects VOB using the function (characteristic line) as necessary, thereby performing display of a size that is easy to see to a certain extent at a far distance, while suppressing the display size from becoming too large at a near distance, and realizing appropriate changes in the display size from a far distance to a near distance to realize perspective display without a sense of discomfort.

Next, when the vehicle 1 moves to a target point that is a predetermined real space position such as an intersection and the vehicle 1 approaches a position ahead of the vehicle 1 by a predetermined distance such as 30 m (“YES” at step ST104), the control unit 701 performs control until the movement controller 703 positions the virtual object VOB and the virtual object VOB reaches the target point on the second route R2 (as viewed from the viewer) as the vehicle 1 travels (step ST105). By performing control in this way, it is possible to cause the virtual object VOB to be visually recognized as if the virtual object is present at a predetermined real space position (target point) in front of the vehicle. In the control after the virtual object VOB is positioned at the target point, the movement controller 703 operates in cooperation with the display size adjustment portion 704 to adjust the display size of the virtual object VOB according to, for example, a distance to a destination acquired from the navigation device 121, and can operate in cooperation with the display position adjustment portion 705 to adjust the display position of the virtual object VOB according to the guidance direction at the predetermined real space position. At this time, the display size and the display position of the virtual object VOB are changed using function (characteristic line) indicating the relationship between the distance and the display size, which is adjusted to a rate of change different from the real world rate of change in size.

Finally, at a predetermined real space position such as an intersection, when the vehicle 1 (the occupant who is the viewer 4) starts the turning maneuver along the guide direction presented by the virtual object VOB (“YES” at step ST106), the virtual object VOB is erased from the screen of the image display unit 113 (display of the virtual object VOB is ended) (step ST107).

The control unit 701 repeatedly performs control to wait until the delay timing is reached when it is determined at step ST102 that it is not the display timing (“No” at step ST102), to wait until the predetermined distance is reached when it is determined at step ST104 that the vehicle 1 does not approach the predetermined distance ahead (“No” at step ST104), and to wait until a turning maneuver by the occupant who is the viewer 4 is detected when the turning maneuver is not detected in step ST106 (“No” at step ST106).

Hereinafter, with reference to FIG. 4 and subsequent drawings, the operation of the steps ST103 and ST105 in FIG. 3 described above as viewed from the viewer 4 will be specifically described.

Reference is made to FIG. 4. FIG. 4 illustrates trajectories of the first route R1 and the second route R2 as viewed from the viewer 4 (here, the driver DR who is an occupant in the vehicle 1). Here, arrowheads of the arrow marks (VOB1, VOB2) as virtual objects VOB in the respective routes indicate the movement directions of the virtual objects VOB, the arrow mark VOB1 on the first route R1 is directed in the same direction as a traveling direction of the vehicle 1 for moving to the target point, and the arrow mark VOB2 on the second route R2 is directed in the opposite direction to the traveling direction of the vehicle 1 for approaching the target point. As illustrated in FIG. 4, the arrow mark VOB1 on the first route R1 is moved away as viewed from the viewer 4 (advance display of moving to the target point), and the distance to the target point can be intuitively conveyed by the height of the arrow mark VOB1 at that time, and the arrow mark VOB2 on the second route R2 is approached as viewed from the viewer 4, and the target point to turn right or left can be intuitively grasped by the height of the arrow mark VOB2 at that time.

Reference is made to FIG. 5. FIG. 5 illustrates a difference in height of the virtual object VOB between the first route R1 and the second route R2. As illustrated in FIG. 5, heights of the arrow marks VOB1 and VOB2 as virtual objects VOB have a relationship of VOB1 <VOB2. In FIG. 5, a portion denoted by F is a footer indicating a speedometer, a legal speed, or the like, which is disposed and displayed in a fixed region below the screen.

In the display control device 700 according to the present embodiment, the control unit 701 performs control to display the virtual object VOB (arrow mark VOB1) on the first route R1 in advance from a near side to a far side, and subsequently display the virtual object VOB (arrow mark VOB2) on the second route R2 so as to approach the near side from the far side. In this way, by performing control to display the virtual object VOB (the arrow marks VOB1 and VOB2) on the near side (lower side) or the far side (upper side) of the screen so as to be shifted from the line of sight of the viewer 4 (the line of sight of the viewer 4 facing the forward horizontal direction) in both the first route R1 and the second route R2, it is possible to secure the field of view of the occupant DR who is the viewer 4, and to clearly and intuitively convey a sense of distance to the target point by the first route and the target point by the second route R2 while suppressing annoyance due to obstruction of the field of view.

Meanwhile, when the virtual object VOB (arrow mark VOB1) is positioned at the target point and the height of the approaching arrow mark VOB2 is at a center of the eye box as the vehicle 1 travels, the arrow mark VOB2 is approaching the center of an eye box, and thus the viewer 4 is clearly disturbed and feel annoyed. When the virtual object VOB2 is positioned at the target point and the height of the approaching arrow mark VOB2 is below the center of the eye box as the vehicle 1 travels, the approaching arrow mark VOB2 is always superimposed on the road surface 6 as viewed from the eye box, and thus the viewer 4 who is viewing the road ahead feels disturbed and annoyed. On the other hand, when the virtual object VOB2 is positioned at the target point and the height of the approaching arrow mark VOB2 is above the center of the eye box, the approaching arrow mark VOB2 is not superimposed on the road surface 6 as viewed from the eye box (in extreme terms, VOB2 is superimposed on the sky), and thus the viewer 4 who is focusing on the road ahead does not feel disturbed and annoyed. Therefore, it is effective to display the virtual object VOB at an upper limit by shifting the virtual object VOB from the center of the angle of view in the sense that the viewer 4 secures the front field of view of the vehicle 1.

In the HUD device 100, the “eye box” is (1) a region in which the entire virtual image of the image to be displayed can be visually recognized, and at least a part of the virtual image (virtual object VOB) of the image to be displayed cannot be visually recognized outside the region, (2) a region in which at least a part of the virtual image of the image to be displayed can be visually recognized and a part of the virtual image cannot be visually recognized outside the region, (3) a region in which at least a part of the virtual image of the image to be displayed can be visually recognized at a predetermined luminance or higher and the entire virtual image has a luminance lower than the predetermined luminance outside the region, or (4) a region in which at least a part of a virtual image can be stereoscopically viewed and a part of the virtual image cannot be stereoscopically viewed outside the region when the HUD device 100 can display a stereoscopically viewable virtual image. That is, when the viewer 4 places the eyes (both eyes) outside the eye box, the viewer 4 cannot visually recognize the entire virtual image of the image, the visibility of the entire virtual image is very low and it is difficult to perceive the virtual image, or the virtual image cannot be stereoscopically viewed. Here, the luminance is, for example, approximately 1/50 with respect to the luminance of the virtual image of the image visually recognized at the center of the eye box. The eye box is set to be the same as the region (also called the eyellipse) where the viewpoint of the viewer 4 is expected to be located in the vehicle 1 in which the HUD device 100 is installed, or to include a large portion of the eyellipse (for example, 80% or more).

Hereinafter, with reference to FIGS. 6A to 7D, trajectories and the like or display forms of virtual objects VOB for each route controlled by the display control device 700 (control section 701) according to the present embodiment will be described as Example 1 to Example 8.

FIG. 6A is a diagram illustrating the trajectory of the second route R2 in an example 1. In FIG. 6A, the control unit 701 (movement controller 703) performs control to gradually increase the height of the arrow mark VOB2 on the second route R2 toward the target point. In this way, by performing control to gradually increase the height of the virtual object VOB (arrow mark VOB2) on the second route R2, it is possible to suppress a sense of discomfort felt in the height of the arrow mark VOB2 at the target point.

FIG. 6B is a diagram illustrating the trajectory of the second route R2 in an example 2. In FIG. 6B, the control unit 701 (movement controller 703) performs control to gradually increase the height of the arrow mark VOB2 which is the virtual object VOB, as the target point is approached when the target point is, for example, within 30 m (first distance) as viewed from the viewer 4, and to make the height of the arrow mark VOB2 constant without depending on the target point when the target point is equal to or greater than the first distance. As a result, it is possible to secure the field of view for the occupant that is the viewer 4 who is preparing for turning maneuver in front of the target point and to suppress the occupant from feeling annoyed, and it is possible for the occupant to perform a smooth turning maneuver such as turning right or left.

FIG. 6C is a diagram illustrating the trajectory of the second route R2 in an example 3. In FIG. 6C, when the target point is within the first distance as viewed from the viewer 4, the control unit 701 (movement controller 703) performs control to gradually increase the height of the arrow mark VOB2 that is the virtual object VOB according to the first elevation rate defined by the height of the arrow mark VOB2 that changes depending on the distance to the target point as the target point is approached, and when the target point is equal to or greater than the first distance, the control unit 701 (movement controller 703) performs control to gradually increase the height of the arrow mark VOB2 at a second elevation rate greater than the first elevation rate as the target point is approached. For example, if it is considered that the height of the arrow mark VOB2 should increase by approximately 1 meter as the distance to the target point decreases by 100 meters, the elevation rate would be 1/100. As described above, by varying the elevation rate, if it is considered that the height of the arrow mark VOB2 increases by 0.5 meters as the distance to the target point decreases from 100 meters to 30 meters (equal to or more than 30 meters), and further increases by 0.5 meters as the distance decreases from the remaining 30 meters to 0 meter, the second elevation rate would be 0.7/70, and the first elevation rate would be 0.5/30. In this way, by controlling the height of the virtual object VOB to gradually increase according to the first elevation rate, it is possible to convey to the occupant who is the viewer that the target point is gradually approached. Furthermore, by controlling the height of the virtual object VOB to gradually increase according to the second elevation rate smaller than the first elevation rate, it is possible to secure the field of view in front of the vehicle and to perform smooth turning maneuver such as turning right or left while suppressing the occupant from feeling annoyed.

FIG. 6D is a diagram illustrating an example of a shaded image VOB′ of a virtual object VOB on the second route R2 in an example 4. In FIG. 6, when the target point is approached by a predetermined amount (for example, 30 m) on the second route R2, the control unit 701 (main controller 702) performs control to acquire a shaded image VOB2′ of the arrow mark VOB2 representing the height of the arrow mark VOB2 as the virtual object VOB and to display the shaded image VOB2′, generated by the image generation portion 112, to be superimposed on the road surface 6. In this way, by displaying a shaded image VOB2′ of the arrow mark VOB2 on the road surface 6, for example, enlarging or darkening a shape of the shaded image VOB2′ so as to be highlighted as the target point gets closer in order to represent the height of the arrow mark VOB2, it is possible to further increase a sense of augmented reality, and as a result, it is possible to attract an attention of the occupant (driver DR) who is the viewer 4.

FIG. 7A is a diagram illustrating the trajectory of the first route R1 in an example 5. In FIG. 7A, the control unit 701 (movement controller 703) performs control to make the height of the arrow mark VOB1 as the virtual object VOB constant without depending on the target point on the first route R1. In this way, the first route R1 (an advance display that makes the virtual object VOB appear to move away) during movement to the target point corresponding to the real space position allows the occupant (driver DR) who is the viewer 4 to perceive (or estimate) the sense of distance to the target point. In other words, by making the height of the virtual object VOB constant, it is easy for the occupant (driver DR) who is the viewer 4 to grasp the distance from the current position of the vehicle 1 to the target point.

FIG. 7B is a diagram illustrating the trajectory of the first route R1 in an example 6. In FIG. 7B, the control unit 701 (movement controller 703) performs control to gradually increase the height of the arrow mark VOB1 as the virtual object VOB on the first route R1 toward the destination. In this way, by performing control to gradually increase the height of the arrow mark VOB1 on the first route R1, it is possible to suppress a sense of discomfort felt in the height of the virtual object VOB (here, arrow mark VOB1) at the target point.

FIG. 7C is a diagram illustrating the trajectory of the first route R1 in an example 7. In FIG. 7C, on the first route R1, the control unit 701 (movement controller 703) performs control to make the height (height a) of the virtual object VOB (arrow mark VOB1) constant without depending on the target point when the target point is at, for example, 10 m (second distance) or more, and to rapidly increase the height b1 (b1>>a) of the arrow mark VOB1 as the virtual object VOB as the target point is moved away when the target point is within 10 m (second distance). In this way, the height of the virtual object VOB is rapidly increased from a constant state at, for example, 10 m (second distance), so that an attention of the occupant who is the viewer 4 can be attracted, and as a result, it is possible to clearly convey the target point to the occupant.

FIG. 7D is a diagram illustrating the trajectory of the first route R1 in an example 8. In FIG. 7D, on the first route R1, the control unit 701 (movement controller 703) performs control to gradually increase the height of the arrow mark VOB1 as the virtual object VOB (from the height a to the height b) as the target point is moved away, and to make the height of the arrow mark VOB1 constant without depending on the distance to the target point when the target point is, for example, within 30 m (within the second distance). In this way, on the first route R1, the virtual object VOB is moved from the lower side (near side) of the angle of view to the target point (the virtual object is moved away to the upper side (far side) of the angle of view), so that it is possible to temporarily secure the field of view of the occupant (driver DR) who is the viewer 4 and suppress annoyance, and thereafter, the height of the virtual object VOB (arrow mark VOB1) is fixed and displayed at a center of the angle of view, so that it is possible to clearly convey the target point to the occupant (driver DR) who is the viewer 4.

### Modification

The above-described display control device 700 according to the present embodiment includes a control unit 701 that performs display control in a case where a virtual object VOB indicating a guidance direction at a target point is displayed in advance so as to move along a road surface 6, the virtual object VOB is positioned at the target point, and the virtual object VOB is visually recognized by an occupant who is a viewer 4 aboard a vehicle 1 as if the virtual object is present at a predetermined real space position in front of the vehicle, wherein the control unit 701 performs control of displaying the virtual object VOB such that a height of the virtual object VOB on a first route R1 when moving to the target point as viewed from the viewer 4 is different from a height of the virtual object VOB on a second route R2 when approaching from the target point as viewed from the viewer 4. On the other hand, when the HUD device 100 incorporates the function of the control unit 701, the HUD device 100 can independently realize a role as the display control device 700.

A configuration of the HUD device 100 in this case (hereinafter, referred to as an HUD device 100A to distinguish from the HUD device 100 illustrated in FIG. 1) is illustrated in FIG. 9 as a modification. As illustrated in FIG. 9, the HUD device 100A of the modification includes a control unit 701a and an image display unit 111a. The control unit 701a performs control to display the virtual object VOB such that a height of the virtual object VOB on the first route R1 when moving to the target point as viewed from the viewer 4 is different from a height of the virtual object VOB on the second route R2 when approaching from the target point as viewed from the viewer 4.

The control unit 701a includes an information acquisition portion 119a, a main controller 702a, a movement controller 703a, a display size adjustment portion 704a, and a display position adjustment portion 705a. The information acquisition portion 119a appropriately acquires measured distance information or the like and supplies the information to the main controller 702a. In performing movement control of the virtual object VOB, the movement controller 703a operates in cooperation with the display size adjustment portion 704a to adjust the display size of the virtual object VOB according to, for example, a distance to a predetermined real space position acquired from the navigation device 121, and can operate in cooperation with the display position adjustment portion 705a to adjust the display position of the virtual object VOB according to the guidance direction at the predetermined real space position.

The display size adjustment portion 704a and the display position adjustment portion 705a can, for example, prepare function (characteristic line) indicating relationships between a distance and a display size adjusted to rates of change different from the real world rate of change in size (rate of change in size corresponding to a real object existing in the real space), and change the display sizes and display positions of the virtual objects VOB using the function (characteristic line) as necessary, thereby performing display of a size that is easy to see to a certain extent at a far distance, while suppressing the display size from becoming too large at a near distance, and realizing appropriate changes in the display size from a far distance to a near distance to realize perspective display without a sense of discomfort.

Here, the image display unit 111a is a parallax-type 3D display device. The image display unit 111a has an image generation portion 112a, a liquid crystal display 113a with an image display surface for displaying an image, a light beam separation portion 114a which has a lenticular lens, a parallax barrier, or the like and separates light emitted from the image display surface into light beams for the left and right eyes, and an optical system 116a. The optical system 116a has a curved mirror (concave mirror or the like) 117 which reflects light from the light beam separation portion 114 and projects display light of an image onto a windshield (member to be projected) 2. However, other optical members (a lens, an auxiliary reflecting mirror, and the like) may be further included.

According to the HUD device 100A of the modification, the control unit 701a performs control to display the virtual object VOB on the image display unit 111a such that a height of the virtual object VOB on the first route R1 when moving to the target point corresponding to a real space position as viewed from the viewer 4 is different from a height of the virtual object VOB on the second route R2 when approaching the target point as viewed from the viewer 4. Therefore, it is possible to provide the HUD device 100A that can accurately and intuitively convey the distance to the target point to the occupant who is the viewer 4 by, for example, the virtual object VOB moving away (advance display of moving to the target point) at a lower position as viewed from the viewer 4 on the first route R1, and can clearly and intuitively convey the target point to turn right or left by, for example, the virtual object VOB approaching at a higher position as viewed from the viewer 4 on the second route R2.

### Effects of Embodiment

The display control device according to the present embodiment is, for example, as illustrated in FIG. 1, the display control device 700 including the control unit 701 for performing display control that can cause the virtual object VOB indicating the guidance direction at the target point to be displayed in advance so as to move along the road surface 6, subsequently position the virtual object VOB at the target point, and cause the viewer 4 aboard the vehicle 1 to visually recognize the virtual object VOB as if the virtual object VOB is present at the predetermined real space position in front of the vehicle 1. The control unit 701 performs control to display the virtual object VOB such that the height of the virtual object (arrow mark VOB1) on a first route (refer to R1 in FIG. 4) when moving to the target point as viewed from the viewer 4, is different from the height of the virtual object VOB (arrow mark VOB2) on a second route (refer to R2 in FIG. 4) when approaching from the target point as viewed from the viewer 4 (refer to FIG. 5).

According to the display control device 700 of the present embodiment, the control unit 701 performs control to display the virtual object VOB such that a height of the arrow mark VOB1 as the virtual object VOB on the first route R1 when moving to the target point as viewed from the viewer 4 is different from a height of the arrow mark VOB2 as the virtual object VOB on the second route R2 when approaching from the target point as viewed from the viewer 4. In this way, it is possible to provide the display control method that can clearly and intuitively convey the distance to the target point to the occupant (driver or the like) who is the viewer 4 by, for example, the arrow mark VOB1 as the virtual object VOB moving away (the control unit 701 performs the advance display such that the virtual object VOB moves to the target point) at a lower position as viewed from the viewer 4 on the first route R1, and can clearly and intuitively convey the target point, for example, the arrow mark VOB2 as the virtual object VOB approaching at a higher position as viewed from the viewer 4 on the second route R2 (the control unit 701 performs control such that the virtual object VOB is approached the target point according to movement of the vehicle 1).

According to the display control device 700 of the present embodiment, the control unit 701 performs control to display the virtual object VOB (arrow mark VOB1) on the first route R1 in advance from a near side to a far side, and subsequently display the virtual object VOB (arrow mark VOB2) on the second route R2 so as to approach the near side from the far side. In this way, by displaying the virtual object VOB (the arrow marks VOB1 and VOB2) on the near side or the far side of the screen so as to be shifted from the line of sight of the viewer 4 (the line of sight of the viewer 4 facing the forward horizontal direction) in both the first route R1 and the second route R2, it is possible to secure the field of view of the occupant who is the viewer 4, and to clearly and intuitively convey a sense of distance to the target point by the first route R1 and the target point by the second route R2 while suppressing annoyance due to obstruction of the field of view.

According to the display control device 700 of the present embodiment, for example, as illustrated in FIGS. 6A and 7B, the control unit 701 performs control to gradually increase the height of the arrow mark VOB1 as the virtual object VOB on the first route R1 (FIG. 7B), and/or the height of the arrow mark VOB1 as the virtual object VOB on the second route R2 (FIG. 6A). In this way, by performing control to gradually increase the height of the virtual object VOB (arrow mark VOB1) on the first route R1, and/or the height of the virtual object VOB (arrow mark VOB2) on the second route R2, it is possible to suppress a sense of discomfort felt by the occupant who is a viewer with respect to the height of the virtual object VOB (arrow marks VOB1 and VOB2) at the target point.

According to the display control device 700 of the present embodiment, for example, as illustrated in FIG. 6B, on the second route R2, when the target point is, for example, within 30 m (first distance), the control unit 701 gradually increases the height of the virtual object VOB (arrow mark VOB2) as the target point is approached, and when the target point is, for example, equal to or greater than 30 m (first distance), the control unit performs control to make the height of the arrow mark VOB2 constant without depending on the target point, so that it is possible to secure the field of view for the occupant that is the viewer 4 who is preparing for turning maneuver in front of the target point and to suppress the occupant from feeling annoyed, and it is possible for the occupant to perform a smooth turning maneuver such as turning right or left.

According to the display control device 700 of the present embodiment, for example, as illustrated in FIG. 6C, on the second route R2, when the target point is within, for example, 30 m (first distance) as viewed from the viewer 2, the control unit 701 performs control to gradually increase the height of the arrow mark VOB2 that is the virtual object VOB according to the first elevation rate defined by the height of the arrow mark VOB2 that changes depending on the distance to the target point as the target point is approached, and when the target point is equal to or greater than 30 m (first distance), the control unit 701 (movement controller 703) performs control to gradually increase the height of the arrow mark R2 at a second elevation rate smaller than the first elevation rate as the target point is approached. Here, for example, if it is considered that the height of the arrow mark VOB2 should increase by approximately 1 meter as the distance to the target point decreases by 100 meters, the elevation rate would be 1/100. By varying the elevation rate, if it is considered that the height increases by 0.5 meters as the distance to the target point decreases from 100 meters to 30 meters (equal to or more than 30 meters), and further increases by 0.5 meters as the distance decreases from the remaining 30 meters to 0 meter, the second elevation rate would be 0.7/70, and the first elevation rate would be 0.5/30. In this case, by controlling the height of the arrow mark VOB2 to gradually increase according to the first elevation rate, it is possible to convey to the occupant who is the viewer that the target point is gradually approached. Furthermore, by controlling the height of the arrow mark VOB2 to gradually increase according to the second elevation rate smaller than the first elevation rate, it is possible to secure the field of view and to perform smooth turning maneuver such as turning right or left while suppressing the occupant from feeling annoyed.

According to the display control device 700 of the present embodiment, for example, as illustrated in FIG. 6D, on the second route R2, when the target point is approached by a predetermined distance (for example, 30 m), the control unit 701 performs control to display the shaded image VOB′ of the virtual object VOB (arrow mark VOB2) representing the height of the virtual object VOB (arrow mark VOB2) so as to be superimposed on the road surface, for example, by performing highlighting such as enlarging or darkening the shape of the shaded image VOB′ as the target point is approached, it is possible to further increase a sense of augmented reality, and as a result, it is possible to attract the occupant who is the viewer 4 to the arrow mark VOB2.

According to the display control device 700 of the present embodiment, for example, as illustrated in FIG. 7A, the control unit 701 performs control to make the height of the arrow mark VOB1 as the virtual object VOB constant without depending on the target point on the first route R1, and thus it is possible to clearly convey (or estimate) the sense of distance to the target point to the occupant who is the viewer 4 by the first route R1 when the arrow mark VOB1 as the virtual object VOB moves to the target point corresponding to the real space position (an advance display that makes the arrow mark VOB1 appear to move away to the target point). In other words, by making the height of the arrow mark VOB1 as the virtual object VOB constant, it is easy for the occupant who is the viewer 4 to grasp the distance from the current position of the vehicle 1 to the target point.

According to the display control device 700 of the present embodiment, for example, as illustrated in FIG. 7C, on the first route R1, the control unit 701 performs control to make the height a of the arrow mark VOB1 as the virtual object VOB constant without depending on the target point when the target point is at, for example, 10 m (second distance) or more, and to rapidly increase the height (b1>>a) of the arrow mark VOB1 as the target point is moved away when the target point is within 10 m (second distance). In this way, the height a of the arrow mark VOB1 as the virtual object VOB is rapidly increased from a constant state at, for example, 10 m (second distance), so that an attention of the occupant who is the viewer 4 can be attracted, and as a result, it is possible to clearly convey the target point to the occupant.

According to the display control device 700 of the present embodiment, for example, as illustrated in FIG. 7D, on the first route R1, the control unit 701 performs control to gradually increase the height of the arrow mark VOB1 as the virtual object VOB as the target point is moved away, and to make the height of the arrow mark VOB1 constant without depending on the distance to the target point when the target point is, for example, within 30 m (within the second distance). In this way, on the first route R1, the arrow mark VOB1 as the virtual object VOB is moved from the lower side (near side of the screen) of the angle of view to the target point (the virtual object is moved away to the upper side (far side) of the angle of view), so that it is possible to temporarily secure the field of view of the occupant who is the viewer 4 and suppress annoyance, and thereafter, the height of the arrow mark VOB1 is fixed and displayed at a center of the angle of view, so that it is possible to clearly convey the target point to the occupant who is the viewer 4.

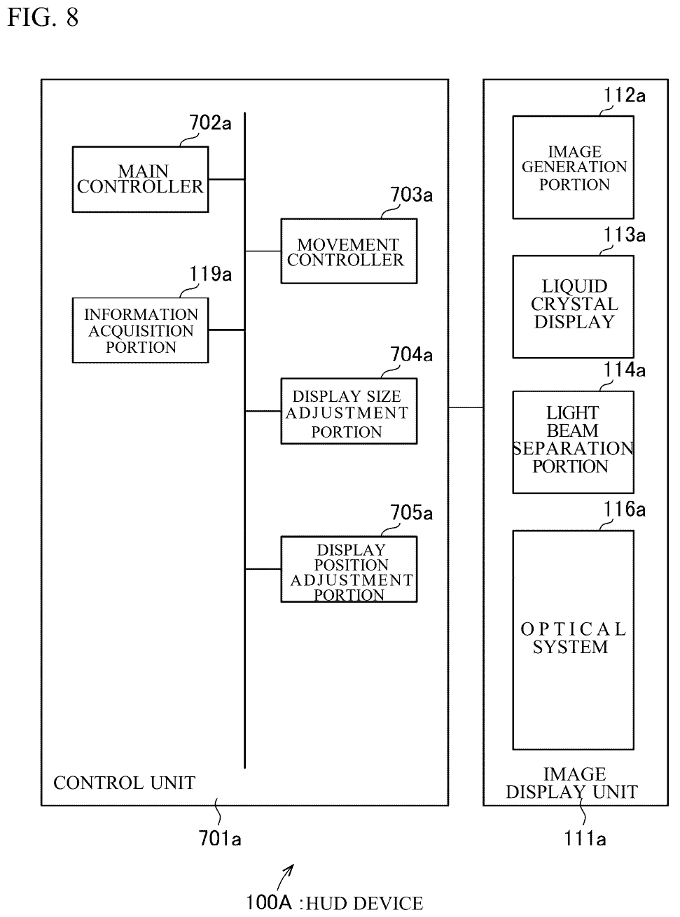

The head-up display device according to the present embodiment is, for example, as illustrated in FIG. 1, an HUD device 100A (refer to FIG. 8) that displays a virtual object VOB so as to be visually recognized by a viewer 4 aboard the vehicle 1 as if the virtual object VOB is present at a predetermined real space position in front of the vehicle 1. The HUD device 100A includes an image display unit 111a and a control unit 701a that performs control to display, on the image display unit 111a, the virtual object VOB (arrow mark VOB1 or VOB2) on the image display unit such that the height of the virtual object VOB (arrow mark VOB1) on the first route R1 (refer to FIG. 4) when moving to the target point corresponding to a real space position as viewed from the viewer 4 is different from the height of the virtual object VOB (arrow mark VOB2) on the second route R2 (refer to FIG. 4) when approaching the target point as viewed from the viewer 4.

According to the HUD device 100 of the present embodiment, the control unit 701a performs control to display the virtual object VOB on the image display unit 111a such that the height of the virtual object VOB (arrow mark VOB1) on the first route R1 when moving to the target point corresponding to a real space position as viewed from the viewer 4 is different from the height of the virtual object VOB (arrow mark VOB2) on the second route R2 when approaching the target point as viewed from the viewer 4. Therefore, it is possible to provide the HUD device 100A that can accurately and clearly convey the distance to the target point to the occupant who is the viewer 4 by, for example, the virtual object VOB (arrow mark VOB1) moving away (advance display of moving to the target point) at a lower position as viewed from the viewer 4 on the first route R1, and can clearly and intuitively convey the target point to turn right or left by, for example, the virtual object VOB (arrow mark VOB2) approaching at a higher position as viewed from the viewer 4 on the second route R2.

The display control method according to the present embodiment is, for example, a display control method for causing the viewer 4 aboard the vehicle 1 to visually recognize the virtual object VOB as if the virtual object VOB is present at a predetermined real space position in front of the vehicle 1, as illustrated in FIG. 1. For example, as illustrated in FIG. 3, the display control method includes a step (ST101) of generating the virtual object VOB indicating the guidance direction at the target point corresponding to the predetermined real space position, and steps (ST102 to ST105) of performing control to display the virtual object VOB such that the height of the virtual object VOB on the first route R1 in moving to the target point as viewed from the viewer 4 is different from the height of the virtual object VOB on the second route R2 in approaching the target point as viewed from the viewer 4.

According to the display control method of the present embodiment, it is possible to provide the display control method that can clearly and intuitively convey the distance to the target point to the occupant who is the viewer 4 by, for example, the arrow mark VOB1 as the virtual object VOB moving away (advance display of moving to the target point) at a lower position as viewed from the viewer 4 on the first route R1, and can accurately and intuitively convey the target point to turn right or left by, for example, the arrow mark VOB2 as the virtual object VOB approaching at a higher position as viewed from the viewer 4 on the second route R2.

The display control program according to the present embodiment is, for example, a display control program of the display control device 700 including the control unit 701 that performs display control for causing the viewer 4 aboard the vehicle 1 to visually recognize the virtual object VOB as if the virtual object VOB is present at a predetermined real space position in front of the vehicle 1, as illustrated in FIG. 1. For example, as illustrated in FIG. 3, the control unit 701 performs a process (ST101) of generating the virtual object VOB indicating the guidance direction at the target point corresponding to the predetermined real space position, and processes (ST102 to ST105) of performing control to display the virtual object VOB such that the height of the arrow mark VOB1 as the virtual object VOB on the first route R1 in moving to the target point as viewed from the viewer 4 is different from the height of the arrow mark VOB2 as the virtual object VOB on the second route R2 in approaching the target point as viewed from the viewer 4.

According to the display control program of the present embodiment, for example, a processor mounted on the control unit 701 of the display control device 700 reads and executes the display control program stored in a memory, so that, on the first route R1, the arrow mark VOB1 as the virtual object VOB moves away at, for example, a lower position as viewed from the viewer 4 (advance display of moving to target point), and thus it is possible to provide the display control program that can clearly and intuitively convey the distance to the target point to the occupant who is the viewer 4 and can clearly and intuitively convey the target point to turn right or left by, for example, the arrow mark VOB2 as the virtual object VOB approaching at a higher position as viewed from the viewer 4 on the second route R2.

For example, as illustrated in FIG. 1, the vehicle display system according to the present embodiment is the vehicle display system 3 including the head-up display device (HUD device 100) that causes a viewer 4 aboard the vehicle 1 to visually recognize a virtual object VOB as if the virtual object VOB is present at a predetermined real space position in front of the vehicle 1, the navigation device 121 that generates navigation information including the target point, and the display control device 700 that performs display control of the HUD device 100. In the vehicle display system 3, the display control device 700 generates the virtual object VOB indicating the guidance direction at the target point acquired by the navigation device 121, and performs control to display the virtual object VOB on the HUD device 100 (refer to FIG. 5) such that the height of the virtual object VOB (arrow mark VOB1) on the first route R1 (refer to FIG. 4) when the vehicle 1 moves to the target point corresponding to the real space position as viewed from the viewer 4 is different from the height of the virtual object VOB (arrow mark VOB2) on the second route R2 (refer to FIG. 4) when the target point is approached as viewed from the viewer 4.

According to the vehicle display system 3 of the present embodiment, the display control device 700 generates the virtual object VOB indicating the guidance direction at the target point acquired by the navigation device 121, and performs control to display the virtual object VOB on the HUD device 100 such that the height of the virtual object VOB on the first route R1 when the vehicle 1 moves to the target point corresponding to the real space position as viewed from the viewer 4 is different from the height of the virtual object VOB on the second route R2 when the target point is approached as viewed from the viewer 4. Therefore, it is possible to provide the vehicle display system 3 that can accurately and intuitively convey the distance to the target point to the occupant who is the viewer 4 by, for example, the arrow mark VOB1 as the virtual object VOB moving away (advance display of moving to the target point) at a lower position as viewed from the viewer 4 on the first route R1, and can clearly and intuitively convey the target point to turn right or left by, for example, the arrow mark VOB2 as the virtual object VOB approaching at a higher position as viewed from the viewer 4 on the second route R2.

The present invention is not limited to the exemplary embodiment described above, and those skilled in the art can easily modify the exemplary embodiment within the scope of the claims.

### REFERENCE SIGNS LIST

1 vehicle (own vehicle)
2 windshield (member to be projected)
3 vehicle display system
4 viewer
6 road surface
43 pupil detection camera
45 imaging camera
46 image processing unit
47 distance measurement portion
48 target type/size detection portion
100, 100A HUD device
111 stereoscopic display device
112 image generation portion
113 image display unit (display panel or the like)
114 light beam separation portion
116 optical system
117 curved mirror
118 light emission window
119 information acquisition portion
120 ECU
121 navigation device
123 communication unit
125 radar unit
700 display control device
701 control unit
702 main controller
703 movement controller
704 display size adjustment portion
705 display position adjustment portion
VOB virtual object
R1 first route
R2 second route
VOB1, VOB2 arrow mark
F footer

1. A display control device including a control unit that performs display control in a case where a virtual object indicating a guidance direction at a target point is displayed in advance so as to move along a road surface, the virtual object is positioned at the target point, and the virtual object is visually recognized by a viewer aboard a vehicle as if the virtual object is present at a predetermined real space position in front of the vehicle, wherein
the control unit performs control of displaying the virtual object such that a height of the virtual object on a first route when moving to the target point as viewed from the viewer is different from a height of the virtual object on a second route when approaching from the target point as viewed from the viewer.

2. The display control device according to claim 1, wherein
the control unit performs control to display the virtual object on the first route in advance from a near side to a far side, and subsequently display the virtual object on the second route so as to approach the near side from the far side.

3. The display control device according to claim 1, wherein
the control unit performs control to gradually increase the height of the virtual object on the first route and/or the height of the virtual object on the second route.

4. The display control device according to claim 3, wherein
when the target point is within a first distance on the second route, the control unit performs control to gradually increase the height of the virtual object as the target point is approached, and when the target point is equal to or greater than the first distance, the control unit performs control to make the height of the virtual object constant independently of the target point.

5. The display control device according to claim 3, wherein
when the target point is within a first distance on the second route, the control unit performs control to gradually increase the height of the virtual object according to a first elevation rate defined by the height of the virtual object that changes depending on the distance to the target point as the target point is approached, and when the target point is equal to or greater than the first distance, the control unit performs control to gradually increase the height of the virtual object at a second elevation rate smaller than the first elevation rate as the target point is approached.

6. The display control device according to claim 1, wherein
when the target point is approached by a predetermined distance on the second route, the control unit performs control to display a shadowed image of the virtual object representing the height of the virtual object to be superimposed on the road surface.

7. The display control device according to claim 3, wherein
the control unit performs control to make the height of the virtual object constant independently of the target point on the first route.

8. The display control device according to claim 3, wherein
on the first route, the control unit performs control to make the height of the virtual object constant independently of the target point when the target point is at a second distance or more, and to rapidly increase the height of the virtual object as the target point is moved away when the target point is within the second distance.

9. The display control device according to claim 3, wherein
the control unit performs control to gradually increase the height of the virtual object as the target point is moved away on the first route, and to make the height of the virtual object constant independently of the distance to the target point when the target point is within a second distance.

10. A head-up display device that displays a virtual object so as to be visually recognized by a viewer aboard a vehicle as if a virtual object is present at a predetermined real space position in front of the vehicle, the head-up display device including:
an image display unit, and
a control unit that performs control to display the virtual object on the image display unit such that a height of the virtual object on a first route in moving to a target point corresponding to the predetermined real space position as viewed from the viewer is different from a height of the virtual object on a second route in approaching the target point as viewed from the viewer.

11. A display control method for causing a viewer aboard a vehicle to visually recognize a virtual object as if the virtual object is present at a predetermined real space position in front of the vehicle, the method including:
a step of generating the virtual object indicating a guidance direction at a target point corresponding to the predetermined real space position, and
a step of performing control to display the virtual object such that a height of the virtual object on a first route in moving to the target point as viewed from the viewer is different from a height of the virtual object on a second route in approaching the target point as viewed from the viewer.
